(19) United States
(12) Patent Application Publication
(10) Pub. No.: US 2014/0046815 A1
(43) Pub. Date: Feb. 13, 2014

(54) Economies of scope data compatibility process

(71) Applicant: Dustin Michael Hartwell, Saginaw, TX (US)

(72) Inventor: Dustin Michael Hartwell, Saginaw, TX (US)

(21) Appl. No.: 13/507,916

(22) Filed: Aug. 7, 2012

(51) Int. Cl. G06Q 40/00

(52) U.S. Cl. CPC G06Q 40/00
USPC 705/35

(57) ABSTRACT

The economies of scope data compatibility process is a process for valuing two inputs when put together as one unit based on a category or a series of categories related to the input by setting parameters or choices for each answer choice. The end result or conclusion will be an outcome of economies of scope, no change or diseconomies of scope when put into the economies of scope formula.

### FEDERALLY SPONSORED RESEARCH

Not Applicable

### SEQUENCE LISTING OR PROGRAM

Formula for degree of economies of scope

Q1+Q2−(Q1,Q2)/(Q1,Q2)

Q1=value results of all variables added together by Q1. Q1=V1+V2+V3+V4+etc.

Q2=value results of all variables added together by Q2. Q2=V1+V2+V3+V4+etc.

C=change in value of results for Q1+Q2 by setting categories for answer choices.

(Q1,Q2)=Q1+Q2+C

V=variable

Value of variables is determined by setting parameters or categories for an answer choice and adding a value for each answer choice or choices for a category or parameter.

(Q1,Q2) is equal to the value of Q1 and Q2 when put together as one unit.

### THE PROCESS

First, set parameters or categories for each variable. An example of a possible variable is Credit Score. An example of parameters or categories for this variable could be: 0-500, 501-640, 641-700, 701-850.

Second, set values associated with each perimeter. An example of values associated with each parameter or category could be: 0-500=value 0, 501-640=value 1, 641-700=value 2, 701-850=value 3.

Third, use Q1 and Q2 information for each variable parameter or category to get a value.

Fourth, then set parameters or categories to make value differences between Q1 and Q2 for each variable. An example of these parameters or categories could be: If the value difference between Q1 and Q2 is 0 or 1 in category or parameter value difference then the result of the change for that variable for (Q1,Q2) is −1 or (C) is equal to −1. which would result in economies of scope for this variable.

If the value difference between Q1 and Q2 is 2 in category or parameter value difference then the result of the change for that variable for (Q1,Q2) is 0 or (C) is equal to 0. which would result in no change.

If the value difference between Q1 and Q2 is 3 in category or parameter value difference then the result of the change for that variable for (Q1,Q2) is +1 or (C) is equal to +1. which would result in diseconomies of scope for this variable.

Fifth, repeat process for all variables.

Sixth, input variable values into degree of economies of scope formula.

| | | | |
|---|---|---|---|
| Q1 = | Variable #1 | Category 1 | Value for category 1 |
| | | Category 2 | Value for category 2 |
| | | Category 3 | Value for category 3 |
| | Variable #2 | Category 1 | Value for category 1 |
| | | Category 2 | Value for category 2 |
| | | Category 3 | Value for category 3 |
| | | | Add chosen values |
| | | | together |
| Q2 = | Variable #1 | Category 1 | Value for category 1 |
| | | Category 2 | Value for category 2 |
| | | Category 3 | Value for category 3 |
| | Variable #2 | Category 1 | Value for category 1 |
| | | Category 2 | Value for category 2 |
| | | Category 3 | Value for category 3 |
| | | | Add chosen values |
| | | | together |
| (Q1, Q2) = | | Set categories for | (C) Value |
| Q1 + Q2 + C | | value differences | category chosen |
| | Variable #1 | Category 1 | Value for category 1 |
| | | Category 2 | Value for category 2 |
| | | Category 3 | Value for category 3 |
| | Variable #2 | Category 1 | Value for category 1 |
| | | Category 2 | Value for category 2 |
| | | Category 3 | Value for category 3 |
| | | | Add Values together |

Insert all values into the formula to find the degree of economies of scope.

Degree of Economies of Scope Formula

Q1+Q2−(Q1,Q2)/(Q1,Q2)

| Example | | | | | | | | (Q1, | |
|---|---|---|---|---|---|---|---|---|---|
| Variables | | | Q1 | | Q2 | | (C) | Q2) | |
| V1 Credit | 0-500 | 0 | | | | | | | |
| Score | 500-640 | 1 | * | | | | | | |
| | 640-700 | 2 | | | | | | | |
| | 700-800 | 3 | | | * | | +1 | | 13 |
| V2 Education | No diploma | 0 | * | | | | | | |
| | High School | 1 | | | | | | | |
| | Bachelors | 2 | | | * | | +1 | | 14 |
| V3 401K | None | 0 | | | | | | | |
| | business owner/ | 1 | | | * | | −1 | | 13 |
| | independent cont. | | | | | | | | |
| | Have one | 1 | * | | | | | | |
| V4 Income | 0-30,000 | 1 | * | | | | | | |
| | 30,001-50,000 | 2 | | | | | | | |
| | 50,001-100,000 | 3 | | | * | | | | |
| | 100,001-infinite | 4 | | | | | +1 | | 14 |
| Totals | | | 3 | + | 9 | = 12 | (+2) | = | 14 |

(Q1,Q2)=14

For variables 1-4.

If variables value is 2 away or more then: +1 for (Q1,Q2) for such quantity 3+ choices

If variable value is less than 2 away then: −1 for (Q1,Q2).

If only two possible point level choices then if the choice is the same then −1 for (Q1,Q2).

If choice point levels are different then +1 for (Q1,Q2)

add the total of change points together and then add them to Q1 and Q2 total points added together. Q1+Q2+C=(Q1,Q2)

### Example Results

Q1+Q2−(Q1,Q2)/(Q1,Q2)

(3)+(9)−14/14=−0.1428

So the results show that diseconomies of scope exists for this example.

### Economies of Scope Data Compatibility Process

### BACKGROUND

1. Field

This process relates to situations where economic analysis can be used to indicate the positive or negative propensities of a decision to combine or merge assets to create a relationship. The relationship could be business or personal in nature.

2. Prior Art

None.

1. A process for valuing two inputs when put together as one unit based on a category or a series of categories related to the input by setting parameters or choices for each category with a value for each answer choice. Which will result in an outcome of economies of scope, no change or diseconomies of scope when put into the scale of economies of scope formula.

2. Q1 and Q2 will include individuals, groups or combinations of groups to determine economies of scope, no change or diseconomies of scope.

3. There can be an unlimited number of variables for Q1 and Q2.

4. There can be an unlimited number of categories for each variable.

5. Variables can be weighted differently based on environment, usage and client needs.
